(19) United States
(12) Patent Application Publication
(10) Pub. No.: US 2022/0402080 A1
(43) Pub. Date: Dec. 22, 2022

(54) Device for Positioning at Least Two Joining Parts During a Welding Process, and Method for Connecting at Least Two Joining Parts by Means of the Device

(71) Applicant: Bayerische Motoren Werke Aktiengesellschaft, Muenchen (DE)

(72) Inventors: Stefan BECK, Kelheim (DE); Hans-Juergen DROTLEFF, Eching-Weixerau (DE); Andre PREETZ, Gardelegen (DE); Alfred SCHERZ, Muenchen (DE)

(21) Appl. No.: 17/777,383

(22) PCT Filed: Nov. 17, 2020
(86) PCT No.: PCT/EP2020/082376

§ 371 Date: May 17, 2022

(30) Foreign Application Priority Data
Dec. 12, 2019 (DE) 10 2019 134 207.4

(51) Int. Cl. B23K 37/06; B23K 26/244; B23K 26/70

(52) U.S. Cl. CPC B23K 37/06; B23K 26/244; B23K 26/702; B23K 2101/18

(57) ABSTRACT

A device for positioning at least two joining parts during a welding process includes a support element. The support element has a surface on which for the joining parts are positioned, a recess under the joining parts when a joining region of the joining parts are on the surface, and a fluid connection for supplying a fluid to the recess. When fluid in the recess is pressurized, during a welding process to connect the joining parts a weld melt is supported by the positive pressure.

### BACKGROUND AND SUMMARY OF THE INVENTION

The invention relates to a device for placing at least two joining parts during a welding process, in which, in order to connect the joining parts, a melt is generated in order to form a weld seam which connects the joining parts. The invention also relates to a method for connecting at least two joining parts by means of the device.

Devices of this kind are used when welding connections of multiple joining parts, in particular metal sheets. In this respect, the joining parts are arranged on the device, in particular are mounted on the device. The joining parts can then be connected by means of a through-weld so that the connection has a satisfactory strength. The welding process is used to generate a melt at the joining parts, which forms a weld seam after solidification. Depending on the material used, more or less pronounced sagging of the underside (root) of the weld seam occurs. This sagging also entails pronounced sinking of the weld seam itself.

In order to counteract the sinking of the weld seam, use is often made of melt bath supports. These are used for supporting the not yet solidified melt at the root from below. Depending on the joining process employed, the melt bath support may be produced from ceramic, steel or other materials.

The melt bath support is designed as a wearing part, with the result that it generally has to be replaced daily, in dependence on the process requirements. This entails high costs and considerable effort for the operator, which have a considerable impact particularly in the case of a high number of weld seams.

A method for joining parts to be joined of dissimilar composition which involves displacing the melt bath at the root is known from DE 10 2015 121 064 B3. In this case, the melt bath is displaced under the influence of a magnetic field; alternatively by means of a gas with overpressure or negative pressure.

The invention is based on the object of proposing a device and a method which allow joining parts to be connected with reduced wear on parts and reduced effort.

This object is achieved by a device according to claim 1 and a method according to claim 8. The respective subclaims provide advantageous configurations of the device and of the method.

The device according to the invention is used to place at least two joining parts during a welding process, in particular during a laser welding process, in which, in order to connect the joining parts, a melt is generated in order to form a weld seam which connects the joining parts. The device comprises a support element which forms a surface for the joining parts, a recess which is introduced into the support element and a fluid port for applying a fluid, preferably a gas, in particular air, to the recess in order to generate an overpressure in the recess and to support the melt by means of the overpressure.

Owing to the support of the melt, a weld seam having no or only a small amount of sinkage is generated. A high quality of the welded connection is thus obtained. At the same time, a melt bath support configured in the form of a wearing part can be dispensed with since this is replaced by the compressed air in the recess provided therefor. This consequently results in a reduced number of wearing parts to be exchanged and, in association therewith, reduced effort.

The joining parts, which may for example be composed of steel or aluminum, may be metal sheets. Prior to the welding, the joining parts are placed onto the device, more precisely onto the surface of the support element, by bringing at least one of the joining parts into direct contact with the surface. The other joining parts do not have to contact the surface, but may also do so. However, it can be sufficient for, for example, a plurality of joining parts to form a stack which is placed onto the support element, in which case only a lowermost joining part is in direct contact with the surface, that is to say rests on the latter. The support element then has the function of a bearing piece or of a bearing block, and so the surface is a bearing surface onto which the joining parts can be placed stacked one above the other.

The joining parts each have a connecting region in which the welded connection is generated, that is to say the melt is generated in order to form the weld seam there for the purpose of connecting the joining parts. The joining parts are in particular arranged on the support element such that the connecting regions are located in the region of the recess. This means that at least the connecting region of the joining part which is arranged directly on the support element or the surface directly adjoins the recess. The connecting regions of the other joining parts may be located in the region of the recess, but may be separated from the recess by the connecting regions of the joining parts which are in each case closer to the recess, so that a weld seam which passes through all of the joining parts and connects them to one another can be generated.

During the welding process, the melt is generated in the connecting region. In this case, a melt bath forms at the root. In order to prevent resultant sagging and sinking of the weld seam, a fluid, preferably a gas, in particular air, is applied to the recess in order to generate an overpressure in the recess and to support the melt, in particular the melt bath, by means of the overpressure. As a result of this effect, an overpressure melt bath support is thus generated.

The recess is preferably in the form of a groove which is introduced into the support element. Due to the configuration as a groove, the latter is defined and delimited in an airtight manner by the walls of the groove. In addition, a configuration which is easy to produce with few individual parts is produced.

In a preferred configuration, the recess is delimited by the support element and a joining part which is positioned on the surface. During the use in which the joining part has been positioned on the surface, the recess is thus delimited on one side by the support element and on the other side by the joining part, with the result that an overpressure can be generated in the recess. As a result, in most cases no additional sealing is required since the joining parts resting on the surface generally seal the recess sufficiently well.

The device preferably comprises a fluid connection which extends through the support element and connects the fluid port to the recess. It is thus possible for the fluid port to be provided, for example, on an outer side of the support element, the fluid being guided through the fluid connection into the recess. This permits particularly good accessibility from the outside.

The device may advantageously comprise a discharge opening which connects the recess to an environment of the device. The discharge opening may in particular be in the form of a groove which is introduced into the support element, and has the effect that residual melt which falls off from the melt does not remain in the recess, but rather is conveyed through the discharge opening out of the recess into the environment. In this respect, the overpressure generated in the recess has the additional auxiliary function of keeping the recess clean. The discharge opening thus results in reduced cleaning effort.

The device preferably comprises a sealing lip for sealing the recess. An additional sealing of the recess by a sealing lip is often not necessarily required, but a sealing lip may be useful in particular in the case of complex geometries of the joining parts to be connected in order to sufficiently seal the recess so that an overpressure can be generated therein. The sealing lip is mounted at an upper edge of the recess at a transition from the recess to the surface of the support element. This results in particularly effective sealing of the recess, which makes it easier to generate the overpressure.

In a preferred configuration, the device may comprise a pressure element for fixing the joining parts on the surface. The pressure element exerts a pressure onto the joining parts in the direction of the surface, so that they are securely fixed thereon. In addition, the pressure exerted onto the joining parts also improves the sealing between the joining parts and the recess.

The method for connecting at least two joining parts, which each have a connecting region, by means of a welding process, in particular a laser welding process, in which a melt is generated in the connecting regions in order to form a weld seam which connects the joining parts, is carried out with the aid of the device according to the invention and comprises the following steps:

placing the joining parts onto the surface in such a way that the connecting regions are located in the region of the recess, applying a fluid to the recess in order to generate an overpressure in the recess, and generating the melt by means of the welding process in order to form the weld seam, wherein the melt is supported by means of the overpressure.

Prior to the welding, the joining parts are placed onto the device, more precisely onto the surface of the support element, by bringing at least one of the joining parts into direct contact with the surface. The other joining parts do not have to contact the surface, but may also do so. A plurality of joining parts may form a stack which is placed onto the support element, in which case only a lowermost joining part is in direct contact with the surface, that is to say rests on the latter.

The joining parts are arranged on the support element such that the connecting regions are located in the region of the recess. This means that at least the connecting region of the joining part which is arranged directly on the support element or the surface directly delimits the recess. The connecting regions of the other joining parts may be located in the region of the recess, but may be separated from the recess by the connecting regions of the joining parts which are in each case closer to the recess, so that a weld seam which passes through all of the joining parts and connects them to one another can be generated.

After the joining parts have been arranged on the support element, a fluid is applied to the recess in order to generate an overpressure, and the welding operation is commenced. In this respect, the melt is generated in the connecting regions. The melt bath which is formed as a result at the root and which adjoins the recess is supported by the overpressure formed in the recess, in order to prevent resultant sagging and sinking of the weld seam.

Owing to the support of the melt, a weld seam having no or only a small amount of sinkage is generated. A high quality of the welded connection is thus obtained. At the same time, a melt bath support configured in the form of a wearing part can be dispensed with since this is replaced by the compressed air in the recess provided therefor. This consequently results in a reduced number of wearing parts to be exchanged and, in association therewith, reduced effort.

Residual melt which falls off from the melt is preferably removed from the recess through a discharge opening by means of the overpressure.

The removal by means of the overpressure has the effect that residual melt which falls off from the melt does not remain in the recess, but rather is conveyed through the discharge opening out of the recess into the environment. In this respect, the overpressure generated in the recess has the auxiliary function of keeping the recess clean. The removal thus results in reduced cleaning effort.

The welding process may preferably be a laser welding process, which permits particularly precise welded connections without influencing the material properties in a large-area manner.

The invention will be described below on the basis of exemplary embodiments.

### BRIEF DESCRIPTION OF THE DRAWINGS

FIG. 1 shows a cross-sectional view of a device according to a first example embodiment of the present invention, and

FIG. 2 shows a cross-sectional view of a device according to a second example embodiment of the present invention, which comprises a discharge opening.

### DETAILED DESCRIPTION

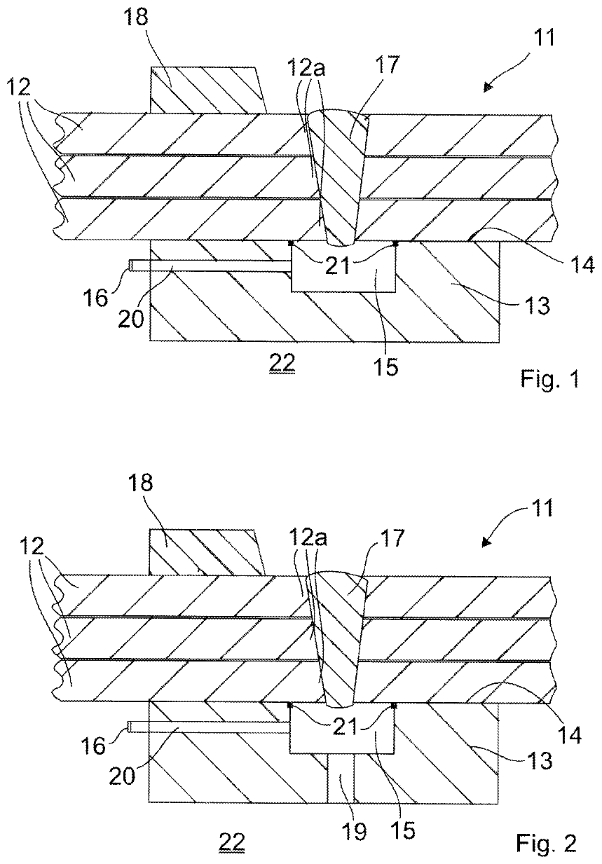

FIGS. 1 and 2 each show a device 11 for placing joining parts 12 during a welding process. The devices 11 according to FIGS. 1 and 2 each comprise a support element 13, a recess 15 and a fluid port 16.

The support element 13 forms a surface 14 which, in the present case, serves as a bearing surface for the joining parts 12, which each have a connecting region 12a. The joining parts 12, in particular metal sheets composed of steel or aluminum, may thus be arranged on the surface 14 and delimit the recess 15, which is in the form of a groove which is introduced into the support element 13, toward the top. The joining parts 12 are additionally pushed downward onto the surface 14 by a pressure element 18, so that they are securely fixed on the surface 14. The recess 15 is delimited toward the bottom by the support element 13.

The recess 15 is generally sufficiently sealed by the joining parts 12, but it may be useful in particular in the case of complex geometries of the joining parts 12 to provide a sealing lip 21, which is mounted at an upper edge of the recess 15 at a transition from the recess 15 to the surface 14 of the support element 13 according to FIGS. 1 and 2. This results in particularly effective sealing of the recess 15, which makes it easier to produce an overpressure.

The fluid port 16 is used to apply a fluid, preferably a gas, in particular air, to the recess 15 in order to generate the overpressure in the recess 15. To this end, a fluid connection 20 extends from the fluid port 16 through the support element 13, which leads into the recess 15.

The devices 11 according to FIGS. 1 and 2 differ in that the device 11 according to FIG. 2 comprises a discharge opening 19 in the form of a discharge groove which is introduced into a lower region of the support element 13. The discharge opening 19 connects the recess 15 to an environment 22 of the device 11.

If at least two joining parts 12 are being connected to one another, these are initially arranged, in particular stacked, on the surface 14 so that the connecting regions 12a are located in the region of the recess 15. This means that at least the connecting region 12a of the joining part 12 which rests directly on the surface 14 has to be arranged such that it is in direct contact with the recess 15. As shown in FIGS. 1 and 2, the connecting regions 12a of the joining parts 12 which do not rest directly on the support element 13 are separated from the recess 15 by the underlying joining parts 12, but are located in a region of the recess 15 so that a weld seam 17 which passes through all of the joining parts 12 and connects them to one another can be generated.

A fluid is then applied to the recess 15 in order to generate an overpressure therein. The welding operation is commenced. In this respect, the melt is generated in the connecting regions 12a in order to form a weld seam 17 which connects the joining parts 12 to one another. In this case, a melt bath which is formed during the welding operation at the root 17a of the weld seam 17 adjoins the recess 15 on account of the arrangement of the connecting regions 12a. The melt bath is supported by the overpressure in the recess 15, in order to avoid sagging and sinking of the weld seam 17.

In this case, a high-quality welded connection is produced, it being possible to dispense with a melt bath support configured in the form of a wearing part. This consequently results in a reduced number of wearing parts to be exchanged and, in association therewith, reduced effort. In the configuration according to FIG. 2, the cleaning effort is also reduced in that residual melt which falls off from the melt is conveyed through the discharge opening 19 into the environment 22 by means of the overpressure prevailing in the recess 15.

### LIST OF REFERENCE DESIGNATIONS

11 Device for placing joining parts
12 Joining part
12a Connecting region
13 Support element
14 Surface
15 Recess
16 Fluid port
17 Weld seam
17a Root
18 Pressure element
19 Discharge opening
20 Fluid connection
21 Sealing lip
22 Environment

1-10. (canceled)

11. A device for joining at least two joining parts, comprising:
a support element having
a surface configured receive and support the at least two joining parts for the placing of the joining parts,
a recess open to the surface, and
a fluid port in communication with the recess,
wherein
the surface, the recess and the fluid port are configured to cooperate with one another such that when the at least two joining parts are located on the surface and a fluid applied via the fluid port into the recess is pressurized, an overpressure in the recess is capable of supporting a weld melt at the one of the at least two joining parts in contact with the surface against weld melt sagging.

12. The device according to claim 11, wherein
the recess is a groove in the support element.

13. The device according to claim 12, wherein
the recess is delimited by the support element and the one of the at least two joining parts in contact with the surface.

14. The device according to claim 13, wherein
a fluid connection extends through the support element such that the fluid port is fluidically connected to the recess.

15. The device according to claim 14, wherein
the support element includes a discharge opening connecting the recess to an environment of the device.

16. The device according to claim 15, wherein
the support element includes a sealing lip configured to seal the recess and the at least against fluid leakage.

17. The device according to claim 11, further comprising:
a pressure element configured to fix the at least two joining parts on the surface.

18. A method for connecting at least two joining parts, each of the at least two joining parts having a connecting region, using a device which includes a support element having a surface configured receive and support the at least two joining parts for the placing of the joining parts, a recess open to the surface, and a fluid port in communication with the recess, comprising the acts of:
placing the at least two joining parts on the surface with their respective connecting regions located in the region of the recess,
applying a fluid to the recess via the fluid port to generate an overpressure in the recess, and
generating a weld melt joining the at least two joining parts using a welding process,
wherein the overpressure supports the weld seam against weld melt sagging.

19. The method according to claim 18, further comprising the act of:
after welding, using the overpressure to discharge through a discharge opening in the support element any residual weld melt which has fallen into the recess.

20. The method according to claim 19, wherein
the welding process is a laser welding process.
